(19) United States
(12) Patent Application Publication
(10) Pub. No.: US 2023/0294091 A1
(43) Pub. Date: Sep. 21, 2023

(54) ELECTROCHEMICAL MICROFLUIDIC ASSAY DEVICES

(71) Applicant: COLORADO STATE UNIVERSITY RESEARCH FOUNDATION, Fort Collins, CO (US)

(72) Inventors: CHARLES S. HENRY, Fort Collins, CO (US); BRIAN J. GEISS, Fort Collins, CO (US); ILHOON JANG, Seoul (KP); ISABELLE SAMPER, Fort Collins, CO (US); ANA SANCHEZ-CANO, Fort Collins, CO (US); DAVID S. DANDY, Fort Collins, CO (US)

(73) Assignee: COLORADO STATE UNIVERSITY RESEARCH FOUNDATION, Fort Collins, CO (US)

(21) Appl. No.: 18/020,335

(22) PCT Filed: Jul. 29, 2021
(86) PCT No.: PCT/US2021/071052

§ 371 Date: Feb. 8, 2023

Related U.S. Application Data
(60) Provisional application No. 63/064,197, filed on Aug. 11, 2020.

(51) Int. Cl. B01L 3/00

(52) U.S. Cl. CPC B01L 3/502715; B01L 2200/16; B01L 2300/0645; B01L 2300/087

(57) ABSTRACT

An assay device includes an electrochemical testing assembly having a test channel including a capture reagent selected to capture a target analyte and an electrode having a surface in communication with the test channel. The assay device further includes a microfluidic network in communication with the test channel, a buffer fluid inlet in communication with the microfluidic network, and a detection reagent disposed within the microfluidic network. When a buffer fluid is provided to the buffer fluid inlet, the buffer fluid transports the detection reagent to the test channel by capillary-driven flow, and wherein the electrode is configured to measure an electrical response indicating capture of the target analyte by the capture reagent after transportation of the detection reagent to the test channel.

### CROSS-REFERENCE TO RELATED APPLICATIONS

This application is related to and claims priority under 35 U.S.C. § 119(e) from U.S. Patent Application No. 63/064,197, filed Aug. 11, 2020, titled “Electrochemical Capillary-Driven Immunoassay,” the entire contents of which are incorporated herein by reference for all purposes.

### TECHNICAL FIELD

Aspects of the present disclosure generally relate to assay devices, and more particularly, to assay devices including microfluidic channels and electrochemical sensing components.

### BACKGROUND

Capillary-driven microfluidic devices have gained popularity in the last decade as alternatives to traditional microfluidics. Instead of using an external pump to induce flow, capillary-driven devices utilize the surface tension of a fluid acting on the channel wall (or fibers in the case of paper) to drive flow. Without the need for a pump, these devices can be operated outside of a centralized lab in resource limited settings without a power source, among other advantages. Pregnancy tests are just one example of capillary-driven analytical devices and their widespread utility as platforms for at-home diagnostics.

Immunoassays are a widely used technology for applications ranging from clinical diagnostics to environmental monitoring. The basis of the immunoassay is the binding event between antigen and antibody, typically performed on a surface. Either the antigen or the antibody can be the target analyte. After this event, the presence of the analyte is detected by one of several methods, including colorimetry, electrochemistry, fluorescence, and chemiluminescence. Among these methods, colorimetry (also called spectroscopic) and fluorescence are the most common. Immunoassays unfortunately rely heavily on laboratory instrumentation and thus, do not work well at the point-of-care or point-of-need. A related technology, the lateral flow assay (LFA) simplifies workflow but lacks the sensitivity and specificity of traditional immunoassays. Despite being a very sensitive method, electrochemical detection is not widely used with immunoassays due to challenges associated with coupling antibodies to the electrodes. However, electrochemistry is widely used for other clinical diagnostics, with the handheld glucometer as one example of this application field.

Considering the foregoing, a need exists for testing devices with the combined ease of use of immunoassays and similar microfluidic testing devices with the increased sensitivity associated with electrochemical testing.

### SUMMARY

In one aspect of the present disclosure, an assay device is provided. The assay device includes an electrochemical testing assembly having a test channel including a capture reagent selected to capture a target analyte. The electrochemical testing assembly further includes an electrode having a surface in communication with the test channel. The assay device also includes a microfluidic network in communication with the test channel, a buffer fluid inlet in communication with the microfluidic network, and a detection reagent disposed within the microfluidic network. When a buffer fluid is provided to the buffer fluid inlet, the buffer fluid transports the detection reagent to the test channel by capillary-driven flow, and wherein the electrode is configured to measure an electrical response indicating capture of the target analyte by the capture reagent after transportation of the detection reagent to the test channel.

In certain implementations, the detection reagent is an electrochemical mediator and the target analyte inhibits interaction between the electrochemical mediator and the electrode when the target analyte is captured by the capture reagent.

In other implementations, the detection reagent is a label selected to bind with the target analyte when the target analyte is captured by the capture reagent and the label is selected to react with a substrate when the label is bound to the target analyte to produce an electrochemically active product detectable by the electrode.

In other implementations, the assay device further includes a substrate inlet in communication with the microfluidic network such that, when a substrate is provided to the substrate inlet, the substrate is transported by capillary-driven flow to the test channel.

In still other implementations, the detection reagent is one of a dried label and a dried substrate disposed within the microfluidic network, and, when the buffer fluid is provided to the buffer fluid inlet, the buffer fluid rehydrates the detection reagent before transporting the detection reagent to the test channel.

In certain implementations, the detection reagent is a first detection reagent including a label and the assay device further includes a second detection reagent disposed within the microfluidic network. The second detection reagent may include a substrate such that, when the buffer fluid is provided to the buffer fluid inlet, the buffer fluid transports the first detection reagent to the test channel before the second detection reagent.

In other implementations, the capture reagent is disposed on the surface of the electrode.

In certain implementations, the assay device further includes a membrane in communication with the microfluidic network and a passive pump coupled to the membrane. The passive pump facilitates capillary-driven flow of the buffer fluid through the microfluidic network when the buffer fluid is provided to the buffer fluid inlet.

In other implementations, the assay device further includes a sample inlet in communication with the microfluidic channel. The sample inlet may include a filtration membrane.

In another aspect of the present disclosure, a method of performing an electrochemical assay is provided. The method includes receiving a buffer fluid at a buffer fluid inlet of an assay device. The assay device includes a microfluidic network in communication with each of the buffer fluid inlet and an electrochemical testing assembly. The electrochemical testing assembly includes a test channel in communication with the microfluidic network, a capture reagent disposed within the test channel and selected to capture a target analyte, and an electrode having a surface in communication with the test channel. The method further includes driving capillary flow of a detection reagent disposed within the microfluidic network to the test channel to the test channel using the buffer fluid and measuring an electrical response with the electrode after arrival of the detection reagent in the test channel. The electrical response indicates capture of the target analyte by the capture reagent.

In certain implementations, the detection reagent is an electrochemical mediator and the target analyte inhibits interaction between the electrochemical mediator and the electrode when the target analyte is captured by the capture reagent.

In other implementations, the detection reagent is a label selected to bind with the target analyte when the target analyte is captured by the capture reagent and the label is selected to react with a substrate when the label is bound to the target analyte to produce an electrochemically active product detectable by the electrode.

In still other implementations, the method further includes receiving a substrate at a substrate inlet of the assay device in communication with the microfluidic network and transporting the substrate to the test channel by capillary flow.

In other implementations, the detection reagent is one of a dried label and a dried substrate disposed within the microfluidic network. In such implementations, the method further includes rehydrating the detection reagent using the buffer fluid before transporting the detection reagent to the test channel.

In other implementations, the detection reagent is a first detection reagent including a label and the method further includes driving capillary flow of a second detection reagent disposed within the microfluidic network to the test channel using the buffer fluid. The second detection reagent includes a substrate, and wherein, the first detection reagent arrives at the test channel before the second test reagent.

In still other implementations, the capture reagent is disposed on the surface of the electrode.

In other implementations, the method further includes receiving a sample by a sample inlet in communication with the microfluidic channel and filtering the sample using a membrane of the sample inlet.

In yet another aspect of the present disclosure, a system for electrochemical for performing electrochemical assays is provided. The system includes a computing device adapted to be communicatively coupled to an electrochemical assay device. The electrochemical assay device includes an electrochemical testing assembly that further includes a test channel including a capture reagent selected to capture a target analyte and an electrode having a surface in communication with the test channel. The electrochemical assay device also includes a microfluidic network in communication with the test channel, a buffer fluid inlet in communication with the microfluidic network and a detection reagent disposed within the microfluidic network. When a buffer fluid is provided to the buffer fluid inlet, the buffer fluid transports the detection reagent to the test channel by capillary-driven flow, wherein the electrode is configured to measure an electrical response indicating capture of the target analyte by the capture reagent after transportation of the detection reagent to the test channel. The computing device is configured to receive measurements from the electrode.

In certain implementations, the computing device is configured to at least one of display the measurements on a display of the computing device, store the measurements in a memory of the computing device, and transmit the measurements to a second computing device.

### BRIEF DESCRIPTION OF THE DRAWINGS

The present disclosure is described in conjunction with the appended figures.

FIGS. 1A-D are schematic illustration of an electrode assembly during various stages of a first electrochemically based test.

FIGS. 2A-E are schematic illustration of an electrode assembly during various stages of a second electrochemically based test.

FIG. 2F is a schematic illustration of an alternative electrode assembly for use in the test of FIGS. 2A-E.

FIG. 3 is a schematic illustration of a first electrochemical testing device according to the present disclosure.

FIGS. 4A-E are schematic illustrations of layers of a device body of the electrochemical testing device of FIG. 3.

FIGS. 5A-C illustrate operation of the electrochemical testing device of FIG. 3.

FIG. 6 is a schematic illustration of a second electrochemical testing device according to the present disclosure.

FIGS. 7A-E illustrate operation of the electrochemical testing device of FIG. 6.

FIG. 8 is a schematic illustration of a third electrochemical testing device according to the present disclosure.

FIGS. 9 and 10 are cross-sectional views of the electrochemical testing device of FIG. 8.

FIGS. 11A-D are schematic illustrations of the electrochemical testing device of FIG. 8 in different stages of performing an assay.

FIG. 12 is a flow chart illustrating a first method of performing an assay using an electrochemical testing device according to the present disclosure.

FIG. 13 is a flow chart illustrating a second method of performing an assay using an electrochemical testing device according to the present disclosure.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

Aspects of the present disclosure are directed to electrochemical sensing devices and electrochemical sensing devices including microfluidic channels that facilitate sequencing of assay steps. Among other things, microfluidic channels are arranged to control flow of various substances through the device, including timing and sequencing of the delivery of those substances to an electrochemical testing assembly

In certain implementations, the disclosed devices may include nitrocellulose, cellulose, or similar passive pumps to perform steps commonly associated with conventional immunoassays and similar testing, but in a format that automates the steps and does not require pipetting. The device may incorporate screen-printed electrodes to enable electrochemical detection of analytes of interest in applied samples. The device can also be designed so that either the electrode itself is modified with the capture reagents, or a nitrocellulose (or cellulose) membrane facing the electrodes is modified with capture reagents. The device can have one or multiple inlets and can incorporate membranes for sample filtration depending on the sample matrix targeted. In at least certain implementations, the device is designed and configured to be disposable.

As noted above, devices according to the present disclosure may include microfluidic channels through which fluids travel by way of capillary action. Capillary-driven microfluidics have been used in many applications, including the detection of bacteria, viruses, biomarkers, pesticides, and heavy metals. In each application, accurate and precise flow control is important to realize the specific analytical function. In analytical applications, flow is conventionally controlled by valving and/or controlling flow rate. Conventional passive control methods, including adjusting the contact angle of surfaces of the microfluidic channels and carefully designing channel geometry, are common ways to realize flow functions because the capillary force is difficult to control once flow begins.

Capillary-driven microfluidics may be made from porous materials like cellulose. Although paper-based devices have shown promise as diagnostic tools, the porous material has similar limitations in particle and reagent transportation, low flow rate, and non-uniform flow as compared to other capillary-driven microfluidics.

Lamination-based methods that stack multiple layers of pre-cut papers or films to form microfluidic channels have been introduced to overcome the limitations of conventional porous-material-based devices. In lamination-based methods, the channel geometry is defined on each layer, then all layers are bonded, e.g., using an adhesive, plasma bonding, or toner. Double-sided adhesive (DSA) may be used for the fabrication of lamination-based microfluidic channels because the hollow channel can be generated directly on the DSA layer through a cutting process. Laminate capillary-driven microfluidic devices fabricated with porous material as one or more walls have shown a large increase in flow rate compared to single-layer configurations. Lamination-based methods can also combine various substrate materials including paper, transparency film, glass, and acrylic. Laminate microfluidic devices composed of transparency films and DSA may also be used for rapid mixing without porous media. More specifically, non-uniform flow and flow resistance caused by cellulose fibers is reduced in laminate microfluidic devices and accurate and rapid flow functions can be realized. In general, laminate devices made of transparency film enable flow and analytical functions that are not achievable in conventional, porous-based capillary-driven channels.

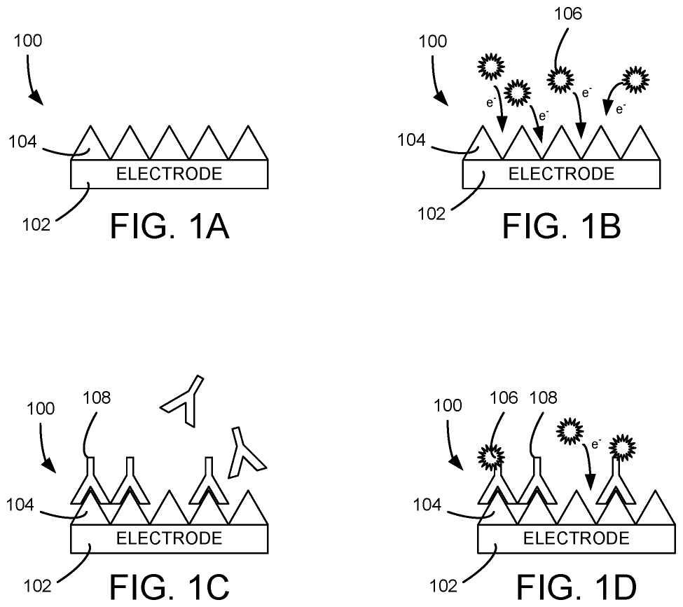

As noted, assay devices according to the present disclosure rely on electrochemistry to measure target analytes within samples. In general, assay devices according to the present disclosure rely on one of two electrochemical phenomena. Referring first to FIG. 1A-D, a first assay mechanism is illustrated in which a target analyte is measured based on inhibition of electron transfer from an electrochemical mediator by the target analyte. Referring first to FIG. 1A, an electrode assembly 100 for use in an electrochemical assay includes an electrode 102 onto which a capture reagent 104 is disposed. Although not limited to specific materials, in at least one implementation, electrode 102 may be a screen-printed carbon electrode or a screen-printed gold electrode. Capture reagent 104 may be selected based on the target analyte. For example, if electrode assembly 100 is intended for use in antibody detection, capture reagent 104 may be a suitable antigen. Conversely, in antigen detection applications, capture reagent 104 may be an appropriate antibody.

Referring to FIG. 1B, electrode assembly 100 is illustrated in the presence of an electrochemical mediator 106. As illustrated, electrons flow relatively freely from electrochemical mediator 106 to electrode 102, thereby producing a first electrical response.

Referring to FIG. 1C, a sample to be tested may be delivered to electrode 102. To the extent the sample includes a target analyte 108, target analyte 108 may bind with capture reagent 104. Accordingly, when electrochemical mediator 106 is applied after target analyte 108 (as shown in FIG. 1D), target analyte 108 may bind with electrochemical mediator 106 or otherwise inhibit or obstruct flow of electrons from electrochemical mediator 106 to electrode 102, thereby producing a second electrical response. Notably, the relative change between the first electrical response and the second electrical response may provide a quantitative measure of the level/concentration of target analyte 108 in the sample provided to electrode assembly 100.

To improve results, one or more washes may be applied during the assay process. For example, a wash may be applied after delivery of the sample to electrode assembly 100 to remove excess sample.

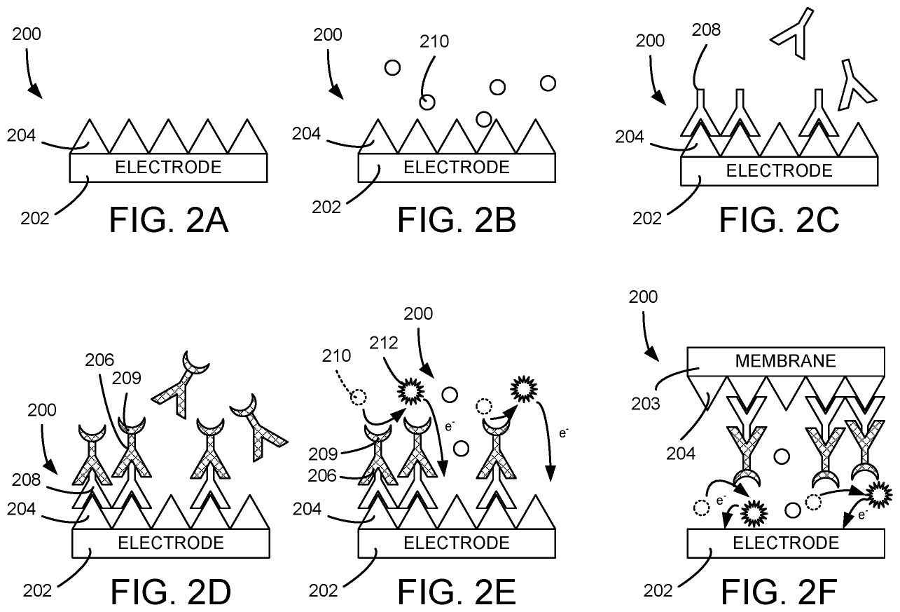

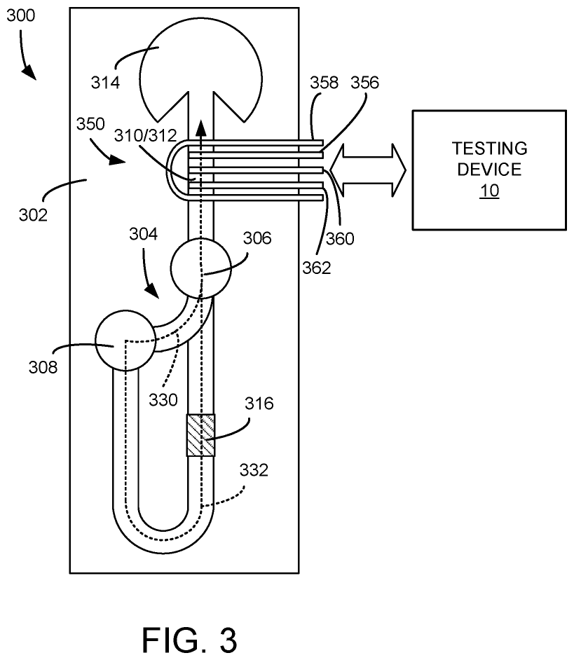

FIGS. 2A-D illustrate a second electrochemical assay mechanism. Referring first to FIG. 2A, an electrode assembly 200 for use in an electrochemical assay includes an electrode 202 onto which a capture reagent 204 is disposed. As described below, the operating principal of electrode assembly 200 generally includes capturing each of a target analyte and label using the capture reagent 204. A substrate is then provided to electrode assembly 200 which reacts with an enzyme of the label to generate an electrical response.

FIG. 2B illustrates electrode assembly 200 in the absence of target analyte and label and presence of a substrate 210. Absent the target analyte and label, substrate 210 remains electrochemically inactive and, as a result, produces a first electrical response (e.g., a non-change) measurable at electrode 202.

In contrast, FIG. 2C illustrates electrode assembly 200 after delivery of a sample including a target analyte 208. As illustrated, target analyte 208 is captured by capture reagent 204 with more target analyte 208 being captured when target analyte 208 is in a higher concentration in the sample. After providing a sample to electrode assembly 200 resulting in capture of target analyte 208 by capture reagent 204, a label 206 may be provided to electrode assembly 200, as illustrated in FIG. 2D. Label 206 is generally selected to bond with target analyte 208 and includes an enzyme 209 for producing an electrically active product from a substrate.

Referring next to FIG. 2E, electrode assembly 200 is illustrated during delivery of substrate 210 with label 206 captured. As illustrated, substrate 210 reacts with enzyme 209 to produce electrochemically active product 212, which, in turn, transfers electrons to electrode 202, generating a second electrical response generally corresponding to the increased electrical activity resulting from generation of electrochemically active product 212.

Like the previous electrochemical assay technique, one or more washes may be applied during the assay process to improve results. For example, a first wash may be applied after delivery of the sample to electrode assembly 200 to remove excess sample from electrode assembly 200 and a second wash may be applied after delivery of label 206 to remove excess label 206 from electrode assembly 200.

FIG. 2F illustrates an alternative implementation and arrangement of electrode assembly 200. Specifically, electrode assembly 200 as illustrated in FIG. 2F includes a membrane 203 (e.g., a nitrocellulose or similar membrane) onto which capture reagent 204 is disposed. Membrane 203 is spaced from electrode 202 such that the sample and reagents (e.g., label 206 and substrate 210) can flow between membrane 203 and electrode 202. The example illustrated in FIGS. 1A-D can also be modified by introducing a membrane offset from electrode 102 with the capture reagent being disposed on the membrane.

Assay devices according to the present disclosure may be configured to perform either of the foregoing electrochemical tests. More specifically and with reference to the technique described in the context of FIGS. 1A-D, assay devices according to the present disclosure may be configured to deliver a sample to a test channel of an electrochemical testing assembly including an electrode and capture reagent selected to capture a target analyte of the sample. Such assay devices are further configured to subsequently and automatically deliver an electrochemical mediator to the test channel, thereby producing an electrochemical response indicating the target analyte and measurable by the electrode. With reference to FIGS. 2A-D, assay devices according to the present disclosure may alternatively be adapted to deliver each of a sample and an enzyme label, in sequence, to a test channel of an electrochemical testing assembly. A substrate may be manually added after delivery of the enzyme label; however, in at least certain implementations, the assay device may be further adapted to automatically deliver the substrate to the test channel as well. In both cases, automatic delivery is by capillary-driven flow through a microfluidic network of the assay device in response to introduction of a buffer fluid to the microfluidic network.

For purposes of the present disclosure, the term detection reagent is used to generally indicate any reagent used in detecting a target analyte at the electrochemical test assembly. So, for example, in the context of the test discussed in FIGS. 1A-D, electrochemical mediator 106 is considered a detection reagent. Similarly, in the context of the test of FIGS. 2A-D, each of the label 206 and substrate 210 are considered detection reagents.

The specific techniques for measuring a target analyte may differ in implementations of the present disclosure. For example, in at least certain implementations, measurements of the target analyte may be obtained by chronoamperometry. In other implementations, other electrochemical measurement methods, such as electrochemical impedance spectroscopy (EIS), square wave voltammetry (SWV), or pulse voltammetry, may alternatively be used. Accordingly, the specific arrangement of electrodes and control circuitry associated with electrochemical test assembly may vary based on the specific type of measurement method being used. Stated differently, the electrochemical test assembly may be of any suitable configuration for obtaining measurements of interest associated with a target analyte.

FIG. 3 is a schematic illustration of a first example assay device 300 for use in performing an assay based on the electrochemical principal discussed above in the context of FIGS. 1A-D. Device 300 includes a device body 302 defining a microfluidic network 304. Device 300 also includes a sample inlet 306 and a buffer inlet 308 in communication with microfluidic network 304. Microfluidic network 304 generally includes microfluidic pathways or channels for transporting fluids provided via sample inlet 306 and buffer inlet 308 to a test channel 310 of an electrochemical test assembly 350. In general, the channels of microfluidic network 304 are configured to transport fluids by capillary action. Such transportation may be facilitated by forming device body 302 from or otherwise applying hydrophilic materials to surfaces of the channels of microfluidic network 304. Transportation may be further facilitated by a nitrocellulose or similar “wicking” membrane 312 extending through test channel 310 alone or in combination with a passive pump 314 coupled to membrane 312. As shown in FIG. 3, passive pump 314 may be in the form of a waste pad that also collects excess fluid transported through electrochemical test assembly 350.

Device 300 further includes a detection reagent disposed within microfluidic network 304. In the specific example illustrated in FIG. 3, the detection reagent is dried on a detection reagent pad 316 (e.g., a glass fiber pad) disposed within microfluidic network 304 and the detection reagent is an electrochemical mediator.

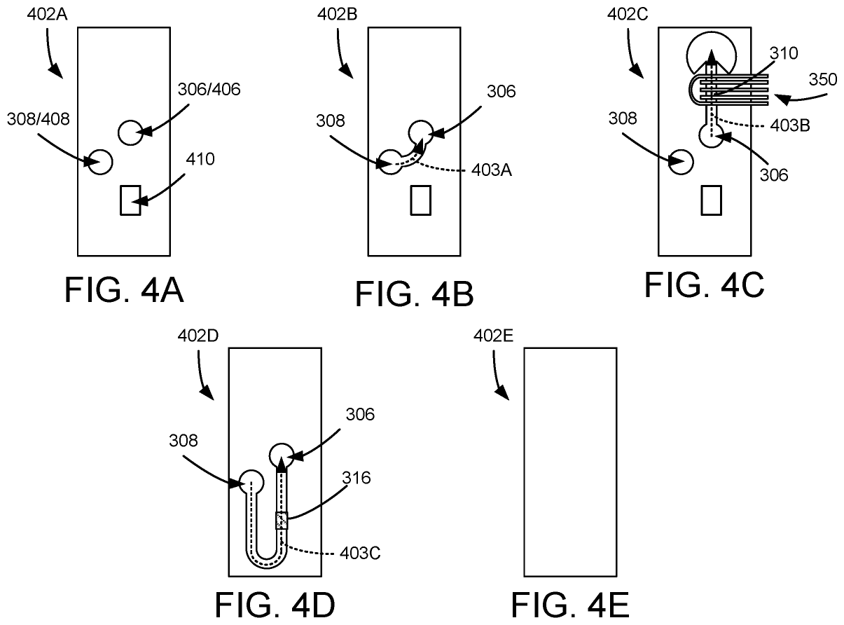

As illustrated, microfluidic network 304 generally includes a first path 330 and a second path 332, each of which extends from buffer inlet 308 through sample inlet 306 and to electrochemical test assembly 350. Notably, however, second path 332 is substantially longer than first path 330. As a result, when buffer fluid is introduced to microfluidic network 304 via buffer inlet 308, at least an initial portion of the buffer fluid that travels along first path 330 will arrive at electrochemical test assembly 350 before an initial portion of the buffer fluid that travels along second path 332, permitting sequencing of the fluid, as described below in further detail in the context of FIGS. 4A-C.

Varying the length of first path 330 and second path 332 is one technique for sequencing fluid delivered to test channel 310 of electrochemical test assembly 350. In other implementations, second path 332 may be modified in other or additional ways to further control sequencing of fluid delivered by first path 330 and second path 332. For example, first path 330 may be treated with a coating or may be formed from a material such that the surface of microfluidic network 304 along first path 330 is more hydrophilic than the surface of microfluidic network 304 along second path 332, thereby increasing capillary flow through first path 330. Cross-sectional geometry of first path 330 and second path 332 may also differ such that capillary flow is increased through first path 330. More generally, however, first path 330 may differ in any suitable way relative to second path 332 such that at least an initial portion of fluid arrives at test channel 310 of electrochemical test assembly 350 via first path 330 before an initial portion of fluid arrives via second path 332.

Electrochemical test assembly 350 includes one or more electrodes for measuring electrochemical activity. Although electrode configurations may differ between implementations, device 300 includes four electrodes: a control electrode 356, a counter electrode 358, a reference electrode 360, and a test electrode 362. As discussed in the context of FIGS. 1A-D, a surface of test electrode 362 may be coated/treated with or otherwise include a capture reagent selected to capture a target analyte of a sample when the sample passes through test channel 310.

Device 300 may generally be coupled to a testing device 10. In general, testing device is configured to obtain and process measurements from electrochemical test assembly 350. Accordingly, testing device 10 may include a suitable interface for coupling with device 300 and for communicating signals and electrical energy to/from device 300. In certain implementations, testing device 10 may be a handheld device, like a glucometer, and may be configured to obtain measurements associated with a target analyte from device 300 and to display a corresponding reading. In other implementations, testing device 10 may be a peripheral for use with a computing device, such as a laptop, smartphone, desktop, etc. In such implementations, testing device 10 may be communicatively coupled to the computing device and may communicate measurements and/or data associated with measurements obtained from electrochemical test assembly 350. The computing device may then display, process, store, etc. the received data. In at least certain implementations, the computing device may be part of or in communication with a broader telehealth system including, but not limited to, an electronic medical records (EMR) system such that data collected using device 300 may be communicated and stored for later access by the user of device 300 or by third parties, such as, but not limited to, a physician or other healthcare professional.

Notably, FIG. 3 illustrates device 300 with portions selectively removed to fully illustrate microfluidic network 304. More specifically, microfluidic network 304 may be distributed through different layers of device body 302 to facilitate the flow of the sample, the buffer fluid, and any detection reagents. For example, in certain implementations, device body 302 may have a layered construction and may be formed by laminating alternating layers of film and double-sided adhesive with each layer being laser cut or otherwise formed to produce microfluidic network 304 when assembled.

FIGS. 4A-E illustrate different layers of device 300 forming microfluidic network 304. Notably, device 300 may include additional layers and the fluid pathways and features illustrated in FIGS. 4A-E may extend vertically across multiple layers of device body 302. For example, any of the layers illustrated in FIGS. 4A-E may be duplicated with duplicates being stacked adjacent each other to increase the height of any pathways defined in the layer. Additional layers may also be used as spacers to accommodate components that may have a height that is greater than a single layer. For example, additional layers may be used to provide sufficient space for detection reagent pad 316, electrochemical test assembly 350, or specific elements of electrochemical test assembly 350.

Referring first to FIG. 4A, a layer 402A of device body 302 is illustrated. As shown, layer 402A is a topmost layer that generally includes various openings for providing access and venting of device 300. Specifically, layer 402A includes a sample opening 406 corresponding to sample inlet 306 to permit introduction of a sample to sample inlet 306, a buffer inlet opening 408 corresponding to buffer inlet 308 to permit introduction of a buffer fluid to buffer inlet 308, and a detection reagent vent 410. In general, each of sample opening 406 and buffer inlet opening 408 also provide venting of microfluidic network 304 in addition to detection reagent vent 410. As discussed below, operation of device 300 includes adding a buffer fluid via buffer inlet 308 that substantially fills microfluidic network 304. Each of sample opening 406, buffer inlet opening 408, and detection reagent vent 410 allows for air to escape from microfluidic network 304 as the buffer fluid fills microfluidic network 304, thereby preventing the formation of bubbles within microfluidic network 304 that may obstruct or impede capillary-driven flow through microfluidic network 304. Notably, each of sample inlet 306, buffer inlet 308, and detection reagent vent 410 may extend through multiple layers of device body 302 to facilitate distribution of buffer fluid to different paths/channels of microfluidic network 304.

FIGS. 4B-D collectively define portions of microfluidic network 304 to facilitate flow of a sample from sample inlet 306 to electrochemical test assembly 350. Microfluidic network 304 further facilitates flow of buffer fluid to electrochemical test assembly 350 along different paths to permit sequencing of reagents delivered to electrochemical test assembly 350. FIG. 4B illustrates a layer 402B disposed below layer 402A and that includes a path segment 403A facilitating fluid communication between sample inlet 306 and buffer inlet 308. Accordingly, when buffer solution is introduced via buffer inlet 308, at least a portion of the buffer solution is transported along path segment 403A to sample inlet 306.

FIG. 4C illustrates a layer 402C generally disposed below layer 402B including a path segment 403B extending between sample inlet 306 and test channel 310 of electrochemical test assembly 350 to facilitate transportation of fluid from buffer inlet 308 to electrochemical test assembly 350.

FIG. 4D illustrates a layer 402D generally disposed below layer 402C that provides a path segment 403C that also extends between sample inlet 306 and buffer inlet 308. Path segment 403C is longer than path segment 403A and includes detection reagent pad 316. Accordingly, fluid transported along path segment 403C may be used to rehydrate detection reagent contained in detection reagent pad 316 and to facilitate transportation of the rehydrated detection reagent to electrochemical test assembly 350 (e.g., by flowing into sample inlet 306 to path segment 403B). Notably, due to the length of path segment 403C being longer than the length of path segment 403A, rehydrated detection reagent will generally be transported to electrochemical test assembly 350 after a sample introduced through sample inlet 306 and a subsequent wash of buffer fluid.

Finally, FIG. 4E illustrates a layer 402E generally that is substantially solid and lacks any cutouts. Accordingly, layer 402E may be used to enclose a lower portion of device body 302. In at least certain implementations, layer 402E may also form a bottom surface of one or more channels of microfluidic network 304.

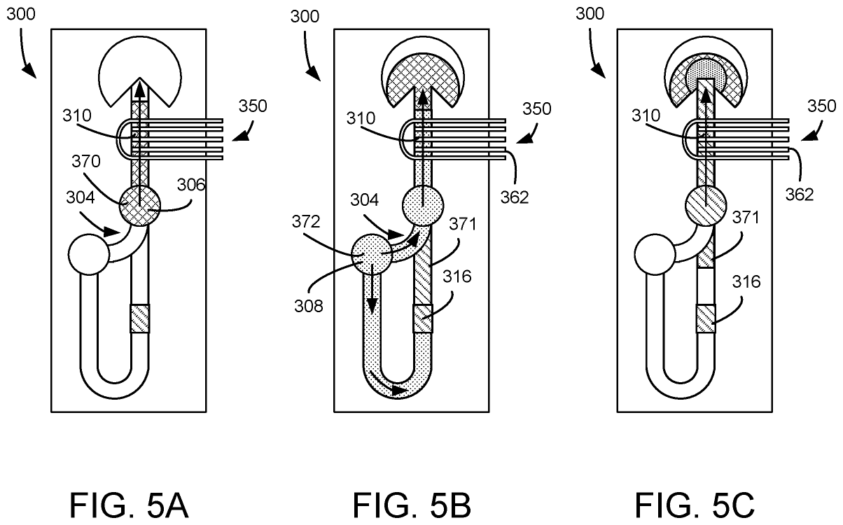

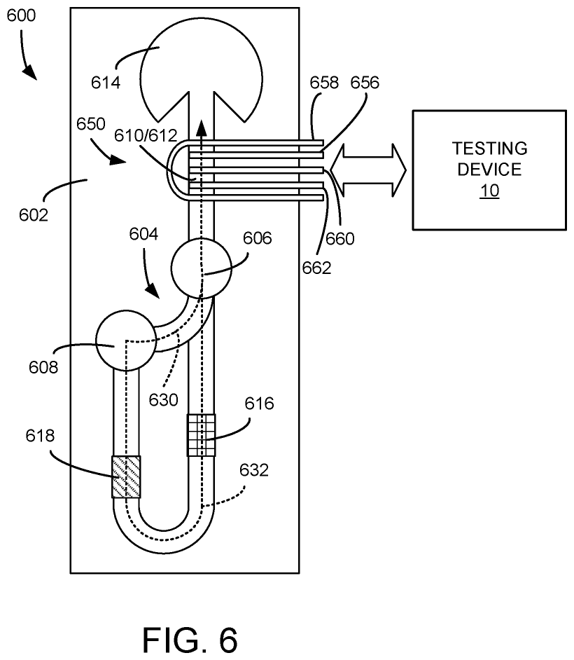

FIGS. 5A-C are a schematic illustration of device 300 that further illustrate operation of device 300 and, in particular, operation of device 300 to perform an assay based on the testing methodology/principles described in the context of FIGS. 1A-D.

Referring first to FIG. 5A, device 300 is illustrated immediately after introduction of a sample 370 via sample inlet 306. As previously noted, sample inlet 306 is in communication with microfluidic network 304, which in turn is in communication with test channel 310 of electrochemical test assembly 350. With specific reference to FIGS. 4A-C, sample 370 may be provided to sample inlet 306 through sample opening 406 and may flow through sample inlet 306 along path segment 403B to electrochemical test assembly 350. As discussed in the context of FIG. 1A-D, in at least certain implementations, flowing sample 370 across electrochemical test assembly 350 may cause a target analyte of sample 370 to bond with a capture reagent of test electrode 362 (or a membrane) of electrochemical test assembly 350.

Referring next to FIG. 5B, a user introduces a buffer fluid 372 into buffer inlet 308 via buffer inlet opening 408 (shown in FIG. 4A). Buffer fluid 372 then flows throughout microfluidic network 304. As buffer fluid 372 flows through microfluidic network 304, at least a portion of buffer fluid 372 may flow along path segment 403A to path segment 403B (see FIGS. 4B and 4C), driving sample 370 through electrochemical test assembly 350. At least some of buffer fluid 372 may follow sample 370 across electrochemical test assembly 350, thereby providing a wash of test electrode 362 that removes excess sample 370. Another portion of buffer fluid 372 flows along path segment 403C (see FIG. 4D), through detection reagent pad 316 to path segment 403B.

As buffer fluid 372 flows along path segment 403C, detection reagent stored in detection reagent pad 316 may be rehydrated and/or transported along path segment 403C to path segment 403B (as detection reagent 371) and, ultimately, electrochemical test assembly 350, as illustrated in FIG. 5C. As discussed in FIGS. 1A-D, in certain implementations, the detection reagent may be an electrochemical mediator such that an electrical response measurable at electrochemical test assembly 350 can be measured using test electrode 362 and may vary based on the amount of target analyte of sample 370 captured by electrochemical test assembly 350.

Notably and as illustrated in FIGS. 5A-C, operation of device 300 generally requires only introduction of sample 370 into sample inlet 306 and subsequent introduction of buffer fluid 372 into buffer inlet 308. Sequential delivery of sample 370, detection reagent 371, and washes of buffer fluid 372 to electrochemical test assembly 350 are otherwise facilitated by the configuration of microfluidic network 304. Stated differently, but for introduction of sample 370 and buffer fluid 372, operation of device 300 is substantially automatic, greatly simplifying use of device 300 while significantly improving the accuracy and overall utility of device 300.

FIG. 6 is a schematic illustration of a second example device 600 for use in performing an assay based on the electrochemical principal discussed above in the context of FIGS. 2A-D. Device 600 includes a device body 602 defining a microfluidic network 604. Device 600 also includes a sample inlet 606 and a buffer inlet 608 in communication with microfluidic network 604. Microfluidic network 604 generally includes microfluidic pathways or channels for transporting fluids provided via sample inlet 606 and buffer inlet 608 to a test channel 610 of an electrochemical test assembly 650. In general, the channels of microfluidic network 604 are configured to transport fluids by capillary action. Such transportation may be facilitated by forming device body 602 from or otherwise applying hydrophilic materials to surfaces of the channels of microfluidic network 604. Transportation may be further facilitated by a nitrocellulose or similar “wicking” membrane 612 extending through test channel 610 alone or in combination with a passive pump 614 coupled to membrane 612. As shown in FIG. 6, passive pump 614 may be in the form of a waste pad that also collects excess fluid transported through electrochemical test assembly 650. Like device 300, device 600 is shown with electrochemical test assembly 650 communicatively coupled to testing device 10.

Electrochemical test assembly 650 includes one or more electrodes for measuring electrochemical activity. Although electrode configurations may differ between implementations, device 600 includes four electrodes: a control electrode 656, a counter electrode 658, a reference electrode 660, and a test electrode 662. As discussed in the context of FIGS. 2A-D, a surface of test electrode 662 may be coated/treated with or otherwise include a capture reagent selected to capture a target analyte of a sample when the sample passes through test channel 610.

Device 600 further includes multiple detection reagents disposed within microfluidic network 604. In the specific example illustrated in FIG. 6, a first detection reagent is dried or otherwise disposed on a first detection reagent pad 616 and a second detection reagent is dried or otherwise disposed on a second detection reagent pad 618, each of first detection reagent pad 616 and second detection reagent pad 618 being disposed within microfluidic network 604. In certain implementations and consistent with the description of FIGS. 2A-D, the first detection reagent may be an enzyme label and the second detection reagent may be a substrate. Accordingly, for purposes of the foregoing discussion, first detection reagent pad 616 may be referred to as an enzyme label pad and second detection reagent pad 618 may alternatively be referred to as a substate reagent pad.

As illustrated, microfluidic network 604 generally includes a first path 630 and a second path 632, each of which extends from buffer inlet 608 through sample inlet 606 and to electrochemical test assembly 650. Notably, however, second path 632 is substantially longer than first path 630. As a result, when buffer fluid is introduced to microfluidic network 604 via buffer inlet 608, at least an initial portion of the buffer fluid that travels along first path 630 will arrive at electrochemical test assembly 650 before an initial portion of the buffer fluid that travels along second path 632, permitting sequencing of the fluid delivered to test channel 610 of electrochemical test assembly 650.

Notably, microfluidic network 604 is substantially like microfluidic network 304 of device 300 albeit with first detection reagent pad 616 and second detection reagent pad 618 disposed along second path 632 instead of detection reagent pad 316 only being disposed along second path 332. Accordingly, except for the addition of second detection reagent pad 618, the construction of device 600 may be substantially like the layered construction illustrated in FIGS. 4A-E for device 300.

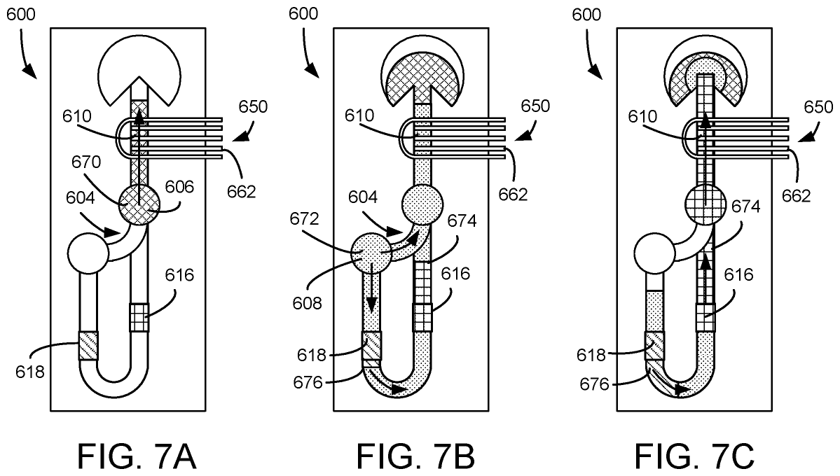

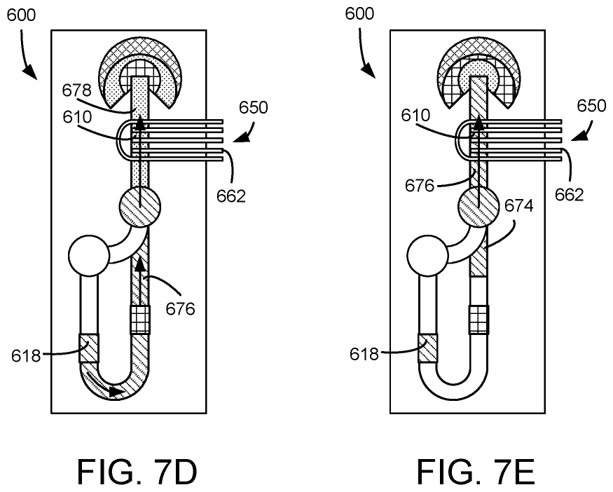

FIGS. 7A-E are schematic illustrations of device 600 that illustrate operation of device 600. Referring first to FIG. 7A, device 600 is illustrated immediately after introduction of a sample 670 via sample inlet 606. As previously noted, sample inlet 606 is in communication with microfluidic network 604, which in turn is in communication with test channel 610 of electrochemical test assembly 350. Accordingly, sample 670 may flow through sample inlet 606 to electrochemical test assembly 650. As discussed in the context of FIGS. 2A-D, in at least certain implementations, flowing sample across electrochemical test assembly 650 may cause a target analyte of sample 670 to bond with a capture reagent of test electrode 662 of electrochemical test assembly 650.

Referring next to FIG. 7B, a user introduces a buffer fluid 672 into buffer inlet 608 via buffer inlet opening 408 (shown in FIG. 4A). Buffer fluid 672 then flows throughout microfluidic network 604. As buffer fluid 672 flows through microfluidic network 604, at least a portion of buffer fluid 672 may flow along path segment 403A to path segment 403B (shown in FIGS. 4B and 4C, respectively), driving sample 670 through electrochemical test assembly 650. At least some of buffer fluid 672 may follow sample 670 across electrochemical test assembly 650, thereby providing a wash of test electrode 662 that removes excess sample 670. Another portion of buffer fluid 672 may flow along path segment 403C (shown in FIG. 4D).

As buffer fluid 672 flows along path segment 403C, detection reagent stored in each of first detection reagent pad 616 and second detection reagent pad 618 may be rehydrated and/or transported toward electrochemical test assembly 650 (as first reagent 674 and second reagent 676). As discussed in FIGS. 2A-D, in certain implementations, detection reagent contained in first detection reagent pad 616, may be an enzyme label and detection reagent contained in second detection reagent pad 618 may be a substrate. The enzyme label may generally be selected to bond with target analyte captured by a capture reagent disposed on test electrode 662 and the substrate may be selected to produce an electrochemically active product in response to reacting with captured enzyme label. Accordingly, delivery of a target analyte, the enzyme label, and the substrate, produces an electrochemical response measurable by test electrode 662.

Notably, the spacing between first detection reagent pad 616 and second detection reagent pad 618 generally results in the first detection reagent being delivered to test channel 610 before the second reagent. Moreover, the spacing between first detection reagent pad 616 and second detection reagent pad 618 may also result in at least a portion of buffer fluid 672 being delivered to test channel 610 between the first reagent and the second reagent, thereby washing excess of the first reagent from test channel 610 prior to delivery of the second reagent.

Considering the foregoing, FIG. 7C illustrates delivery of a first reagent 674 initially stored in first detection reagent pad 616 to test channel 610, FIG. 7D illustrates delivery of a subsequent wash 678 of buffer fluid 672, and FIG. 7E illustrates delivery of a second reagent 676 initially stored in second detection reagent pad 618 to test channel 610.

Like the operation of device 300, as illustrated in FIGS. 5A-C, operation of device 600 generally requires only introduction of sample 670 into sample inlet 606 and subsequent introduction of buffer fluid 672 into buffer inlet 608. Sequential delivery of sample 670, first reagent 674, second reagent 676, and washes of buffer fluid 672 to electrochemical test assembly 650 are otherwise facilitated by the configuration of microfluidic network 604, substantially automating and simplifying operation of device 600.

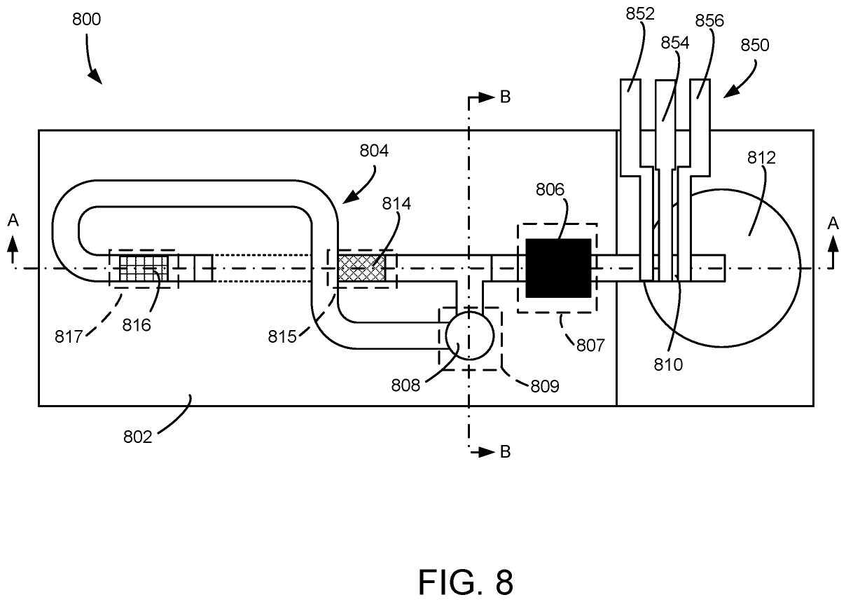

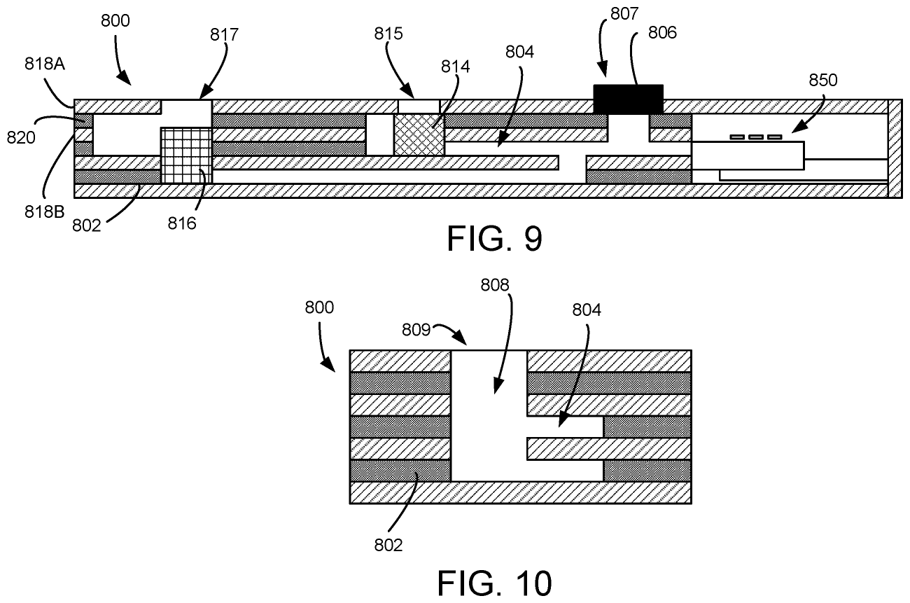

FIGS. 8-10 illustrate another example of an assay device according to the present disclosure. More specifically, FIG. 8 is a plan view of a device 800 while FIGS. 9 and 10 are cross-sectional views taken along A-A and B-B, respectively.

As illustrated, device 800 includes a device body 802 defining a microfluidic network 804. Device 800 includes a sample inlet 806 and a buffer inlet 808 in communication with microfluidic network 804. Microfluidic network 804 generally includes microfluidic pathways or channels for transporting fluids provided via sample inlet 806 and buffer inlet 808 to an electrochemical testing assembly 850. In general, the channels of microfluidic network 804 are configured to transport fluids by capillary action. Such transportation may be facilitated by forming device body 802 from or otherwise applying hydrophilic materials to surfaces of the channels of microfluidic network 804. Transportation may be further facilitated by a test channel 810 including nitrocellulose or similar “wicking” substrate alone or in combination with a passive pump 812. As shown in FIG. 8, passive pump 812 may be in the form of a waste pad that also collects excess fluid from test channel 810.

As illustrated, electrochemical testing assembly 850 includes each of a reference electrode 852, a working electrode 854, and a control electrode 856; however, other electrode arrangements are contemplated herein. In at least certain implementations, electrochemical testing assembly 850 may be coupleable to a testing device, such as testing device 10 previously discussed herein, to collect and/or display measurements obtained using electrochemical testing assembly 850. For example, electrochemical testing assembly 850 in conjunction with the testing device may be configured to obtain measurements using the various electrodes of electrochemical testing assembly 850 and to display, transmit, store, process, etc. corresponding data. In certain implementations, and without limitation, testing device may be a standalone device (like a glucometer), a peripheral device configured to communicated via a wired or wireless connection to a computing device, or a computing device including a corresponding interface.

Device 800 is generally configured to perform an assay like that described above in the context of FIGS. 2A-D, in which a first detection reagent (e.g., an enzyme label) is initially delivered to the test channel 810 followed by a second detection reagent (e.g., a substrate selected to react to the enzyme label to produce an electrochemically active product). Accordingly, device includes a first detection reagent pad 814 (e.g., containing dried enzyme label) and a second detection reagent second detection reagent pad 816 (e.g., containing substrate) disposed within microfluidic network 804. In other implementations, device 800 may be adapted to perform different assays by changing, adding, removing, or otherwise modifying the specific detection reagents included in microfluidic network 804. Such modification may include adding additional paths of microfluidic network 804 for delivery of additional reagents. Modification of device 800 to perform other tests/assay may also or alternatively include reconfiguring electrochemical testing assembly 850, such as by modifying electrode types and arrangements or implementing different processing routines for measurements obtained by electrochemical testing assembly 850.

Although not illustrated, in certain implementations, at least one of the detection reagent pads may be replaced by reagent dried directly onto a surface of and within microfluidic network 804. In still other implementations, detection reagent pads may instead by replaced by additional fluid inlets for manual introduction of detection reagents. For example, in certain implementations, device 800 may include a reagent inlet in communication with microfluidic network 804 that permits manual introduction of one or more reagents by a user. Although the reagent inlet may be disposed at any suitable location along microfluidic network 804, in at least certain implementations, the reagent inlet may be disposed between sample inlet 806 and electrochemical testing assembly 850.

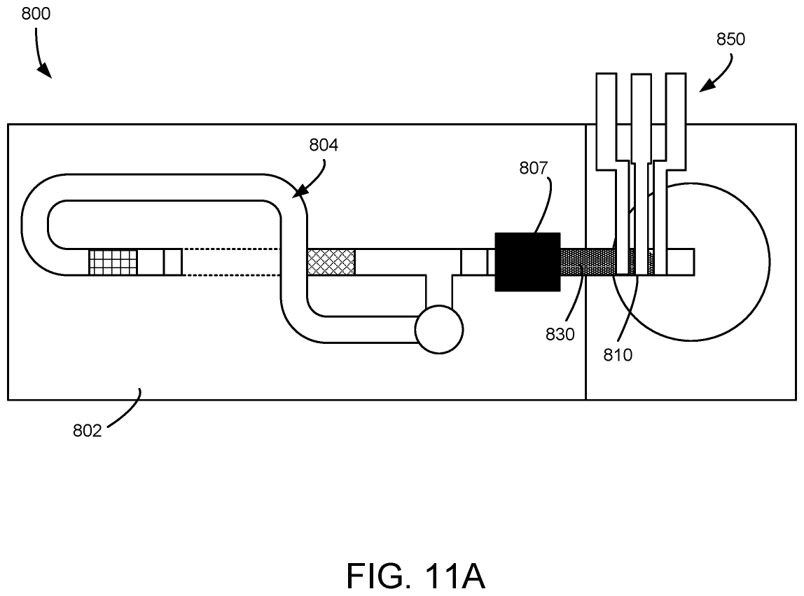

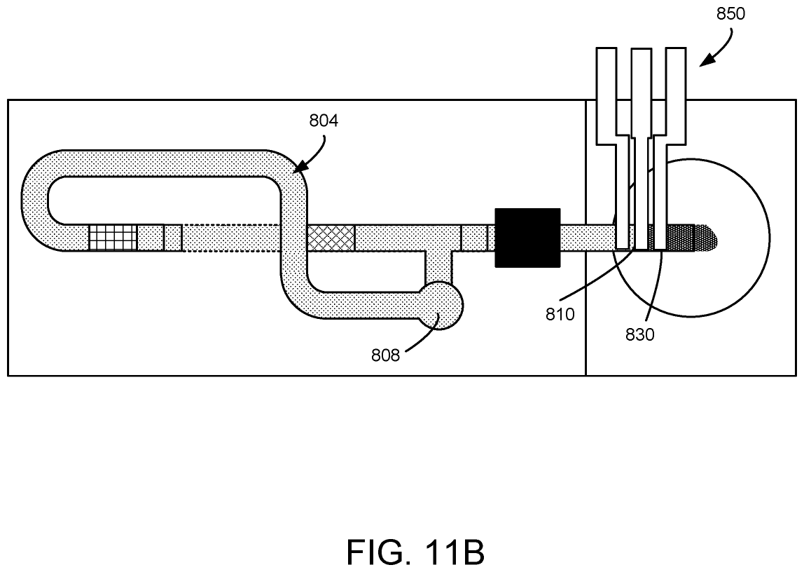

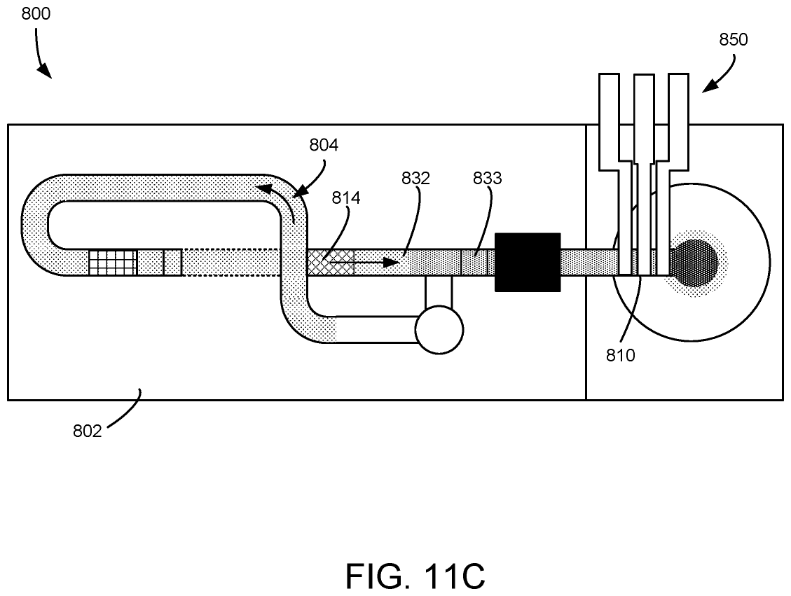

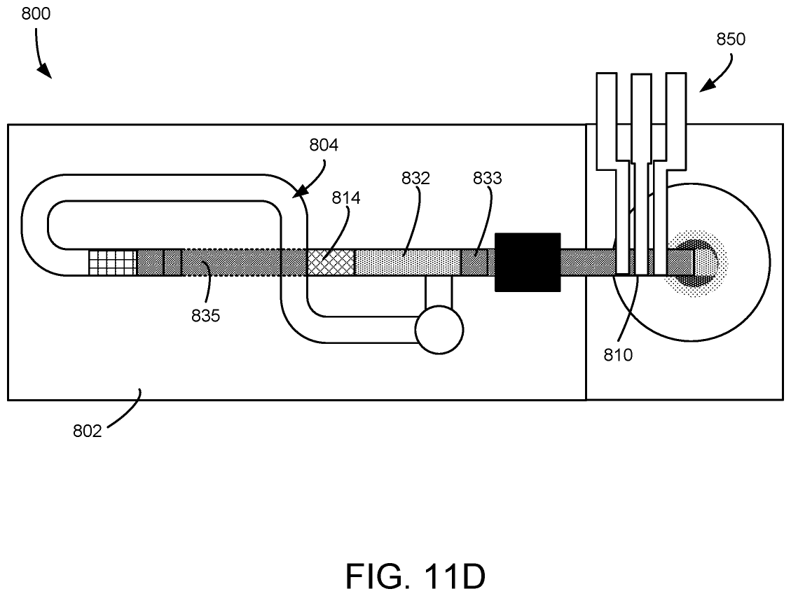

As described below in further detail in the context of FIGS. 11A-D, the configuration of device 800 is such that a sample, enzyme label, and substrate (or other detection reagents) are delivered to test channel 810 sequentially and with intervening washes. To do so, a user of device 800 provides a sample via sample inlet 806, which may be transported to test channel 810, e.g., by capillary action. The user subsequently provides a buffer fluid via buffer inlet 808, which flows through microfluidic network 804. Addition of the buffer fluid may further drive or transport additional sample to test channel 810 and, after delivery of the sample, may provide a wash of excess sample from test channel 810. The buffer fluid within the microfluidic network 804 rehydrates and/or transports detection reagents stored on first detection reagent pad 814 and second detection reagent 816 and enables transportation of the detection reagents to test channel 810.

As illustrated in FIG. 8, first detection reagent pad 814 is positioned within microfluidic network 804 relative to second detection reagent pad 816 such that enzyme label (or other detection reagent stored on first detection reagent pad 814) arrives at test channel 810 before substrate (or other detection reagent stored on second detection reagent pad 816). Due to the spacing between first detection reagent pad 814 and second detection reagent pad 816, a plug of buffer fluid is subsequently delivered, washing test channel 810 of excess enzyme label. As capillary driven flow continues, substrate from second detection reagent pad 816 is delivered to test channel 810, generally completing the test process. After delivery of the substrate, a certain time may be required to elapse before an electrochemical response is measurable using electrochemical testing assembly 850 and indicating the result of the assay.

In certain implementations, a sample may require processing as part of the testing process. In such cases, sample inlet may include a filter, membrane, or similar component for processing the sample. For example, when testing blood, sample inlet 806 may include a plasma or similar membrane to separate blood components.

As previously noted, FIGS. 9 and 10 are cross-sectional views of device 800 along A-A and B-B, respectively. As shown, device body 802 may be formed from multiple laminated layers of material coupled together. For example, in certain implementations, device body 802 may be formed by alternating layers of film (e.g., film layers 818A, 818B) and double-sided adhesive material (e.g., double-sided adhesive layer 820), each of which may be cut (e.g., laser cut) or otherwise formed to produce microfluidic network 804. Accordingly, assembly of device 800 may include forming, stacking, and adhering layers of device body 802. During such assembly, additional components (e.g., first detection reagent pad 814 and second detection reagent pad 816) may be disposed within device body 802, as required. In other implementations, other manufacturing techniques may be used. For example, and without limitation, in at least certain implementations, device body 802 may be formed by 3D printing or related techniques.

In FIG. 8, device 800 is generally illustrated with certain portions of device body 802 selectively removed to better illustrate aspects of device 800 and, more specifically, microfluidic network 804. Accordingly, in at least certain implementations, device body 802 may include a topmost layer (e.g., layer 818A) that substantially covers and contains microfluidic network 804 and components disposed therein, as generally illustrated in FIGS. 9 and 10. Notably, the topmost layer may include various openings for providing various functions. In addition to openings to permit introduction of samples and/or buffer fluid (e.g., a sample inlet opening 807 corresponding to sample inlet 806 and a buffer inlet opening 809 corresponding to buffer inlet 808), the topmost layer may include vents or similar openings corresponding to each of first detection reagent pad 814 and second detection reagent pad 816. For example, device body 802 includes each of a first vent 815 for first detection reagent pad 814 and a second vent 817 for second detection reagent pad 816. General locations for each of the foregoing vents are also illustrated in long dashed lines in FIG. 8. As discussed below, such venting functions permit proper filling of device 800 with buffer fluid and generally preclude the formation of air bubbles that may negatively impact or disrupt flow through microfluidic network 804.

A discussion of the use of device 800 is now provided with reference to FIGS. 11A-D.

Referring first to FIG. 11A, a sample 830 is added to sample inlet 806. As previously noted, adding sample 830 to sample inlet 806 may include processing (e.g., filtering using a plasma membrane) by a corresponding component integrated into sample inlet 806. Sample inlet 806 is in communication with microfluidic network 804. As illustrated, at least a portion of sample 830 (which may be a filtered component of a whole sample) may be transported to test channel 810 by capillary action and further facilitated by a cellulose or similar passive pumping mechanism. In certain implementations, such pumping functionality may be provided by test channel 810, optional passive pump 812, or a combination therefore.

Referring next to FIG. 11B, a user adds a buffer fluid 832 via buffer inlet 808. Buffer inlet 808 is in communication with microfluidic network 804 such that adding buffer fluid 832 via buffer inlet 808 results in buffer fluid 832 being distributed substantially throughout microfluidic network 804 by capillary action. When added, at least a portion of buffer fluid 832 may further drive transport of sample 830 across test channel 810. After sample 830 is substantially driven across test channel 810, a plug/portion of buffer fluid 832 may follow, thereby washing excess of sample 830 from test channel 810.

FIG. 11C illustrates device 800 during delivery of rehydrated enzyme label (or other detection reagent) from first detection reagent pad 814. More specifically, after introduction of buffer fluid 832, at least a portion of a first detection reagent stored on first detection reagent pad 814 may be rehydrated and/or transported by buffer fluid 832 through microfluidic network 804. Like the washing step performed when introducing buffer fluid 832, which resulted from a portion of buffer fluid 832 following sample 830 across test channel 810, another portion of buffer fluid 832 may follow first detection reagent 833 through test channel 810 to perform an additional washing step that removes excess of first detection reagent 833 from test channel 810.

As shown in FIG. 11D, buffer fluid 832 rehydrates a second detection reagent stored on second detection reagent pad 816 to produce rehydrated substrate 835. Rehydrated substrate 835 is transported through microfluidic network 804 to test channel 810. In device 800, such transportation includes transporting rehydrated substrate 835 by capillary action along a path/channel of microfluidic network 804 that extends through a lower layer of device body 802 and that emerges upstream of test channel 810. When rehydrated substrate 835 ultimately arrives at test channel 810, it reacts with the previously delivered rehydrated enzyme label 833 and sample 830, resulting in an electrochemical reaction and corresponding electrical response measurable using working electrode 854 of electrochemical testing assembly 850.

Like the operation of device 300 and device 600, described above, device 800 is generally configured to require minimal steps to be performed by a user. For example, as described above in the context of FIGS. 11A-D, a user of device 800 is generally only required to introduce sample 830 into sample inlet 806 and subsequent introduction of buffer fluid 832 into buffer inlet 808. Sequential delivery of the sample, reagents, and washed are otherwise facilitated by the configuration of microfluidic network 804, substantially automating and simplifying operation of device 800.

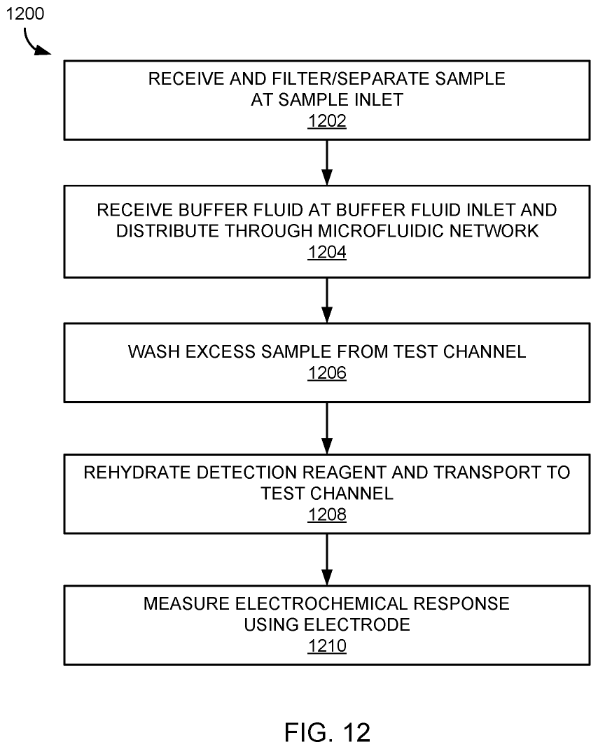

FIG. 12 is a flow chart of a first method 1200 of performing an assay using an assay device according to the present disclosure, such as device 300 of FIG. 3, that requires a single detection reagent to perform an assay. At operation 1202, a sample is received at a sample inlet of an assay device. The assay device includes a microfluidic network in communication with each of the fluid inlet and an electrochemical testing assembly including a test channel. In certain implementations, the sample is filtered, e.g., using a plasma membrane. The sample may also be driven, at least partially, to the test channel by capillary-driven flow when the sample is introduced.

In certain implementations, the electrochemical testing assembly includes an electrode in communication with the test channel. The electrode may have a capture reagent disposed on its surface selected to capture a target analyte. Accordingly, as the sample is transported through the test channel, target analyte contained in the sample may be captured and retained by the capture reagent.

At operation 1204, a buffer fluid is received at a buffer fluid inlet of the assay device. The buffer fluid may substantially fill the microfluidic network and addition of the buffer fluid may generally initiate capillary-driven flow through the microfluidic network. Capillary-driven flow may also be facilitated by a passive pump in communication with the microfluidic network.

At operation 1206, the buffer fluid flows across the test channel, washing excess sample from the detection area.

At operation 1208, a detection reagent is delivered to the test channel. In certain implementations, delivery of the detection reagent may include or be preceded by rehydration of a dried amount of the detection reagent disposed within the microfluidic network (e.g., on a pad disposed within the microfluidic network). When the buffer fluid is added, the buffer fluid may therefore rehydrate the dried detection reagent and may initiate transportation of the rehydrated detection reagent to the testing channel. In at least certain implementations, the dried detection reagent may be an electrochemical moderator.

At operation 1210, an electrochemical response is measured using the electrode of the electrochemical testing assembly. More specifically, delivery of the rehydrated detection reagent to the test channel of the electrochemical testing assembly may generally result in an electrical response measurable using the electrode. The characteristics of the electrical response may generally vary based on the amount of target analyte captured by the capture reagent disposed on the electrode. For example, captured target analyte may inhibit electron flow to the electrode, thereby reducing the electrical response that would otherwise occur in the absence of the target analyte. Based on the response, an amount of captured target analyte and a corresponding concentration of the target analyte within the provided sample may be ascertained.

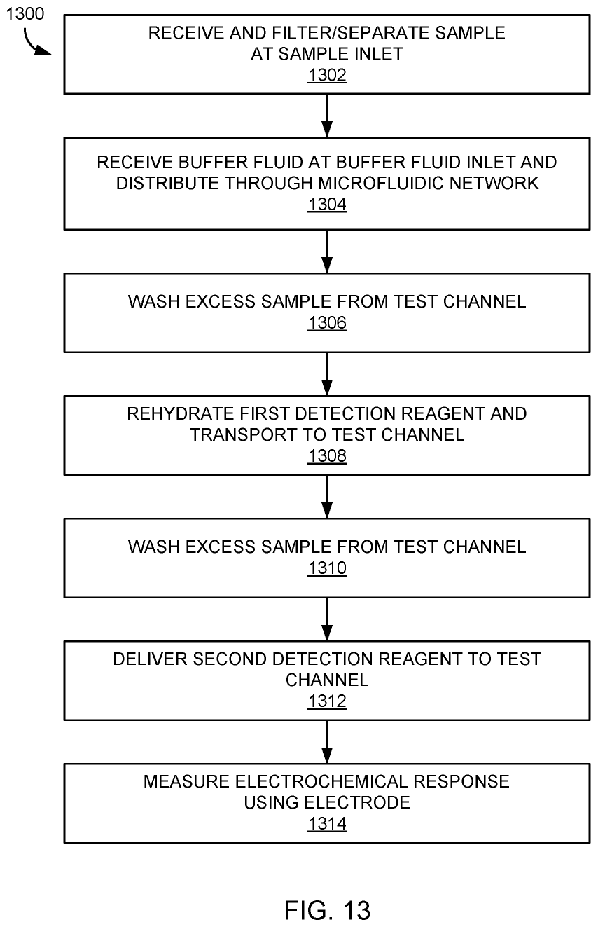

FIG. 13 is a flow chart of a first method 1300 of performing an assay using an assay device according to the present disclosure, such as device 300 of FIG. 3. At operation 1302, a sample is received at a sample inlet of an assay device. The assay device includes a microfluidic network in communication with each of the fluid inlet and an electrochemical testing assembly including a test channel. In certain implementations, the sample is filtered, e.g., using a plasma membrane. The sample may also be driven, at least partially, to the test channel by capillary-driven flow when the sample is introduced.

In certain implementations, the electrochemical testing assembly includes an electrode in communication with the test channel. The electrode may have a capture reagent disposed on its surface selected to capture a target analyte. Accordingly, as the sample is transported through the test channel, target analyte contained in the sample may be captured and retained by the capture reagent.

At operation 1304, a buffer fluid is received at a buffer fluid inlet of the assay device. The buffer fluid may substantially fill the microfluidic network and addition of the buffer fluid may generally initiate capillary-driven flow through the microfluidic network. Capillary-driven flow may also be facilitated by a passive pump in communication with the microfluidic network.

At operation 1306, the buffer fluid flows across the test channel, washing excess sample from the detection area.

At operation 1308, a first detection reagent is delivered to the test channel. In certain implementations, delivery of the first detection reagent may include or be preceded by rehydration of a dried amount of the detection reagent disposed within the microfluidic network (e.g., on a pad disposed within the microfluidic network). When the buffer fluid is added, the buffer fluid may therefore rehydrate the dried detection reagent and may initiate transportation of the rehydrated detection reagent to the testing channel. In at least certain implementations, the dried detection reagent may be an enzyme label.

At operation 1310, a second wash may be applied to the test channel and, at operation 1312, a second detection reagent may be delivered to the test channel. In certain implementations, the second reagent may be a substrate selected to react with the first detection reagent to produce an electrochemically active product.

Finally, at operation 1314, an electrochemical response may be measured using a working or test electrode of the electrochemical testing device. Such measurement may further include receiving the measurement at a testing device or computing device in communication with a testing device and displaying, storing, processing, transmitting, or otherwise performing similar computing operations based on the obtained measurement.

As previously discussed herein, electrochemical testing devices according to the present disclosure may be communicatively coupled to a computing device in coordination with an assay performed using the electrochemical testing device. Accordingly, after measuring the electrical response, a corresponding metric or value may be displayed, transmitted, stored, or otherwise processed by the computing device. For example, in certain implementations, the computing device may be configured to display a metric for the target analyte based on the measured response. In other implementations, the computing device may be configured to transmit a value or metric to another computing device for storage and/or additional processing. In at least certain implementations, the electrochemical testing assembly may be communicatively coupled to a first computing device that, in turn, is connected to a second computing device using a wired or wireless connection. For example, the electrochemical testing device may be coupled to a reader device that reads the measurements obtained using the electrochemical testing assembly and then transmits corresponding result data to another computing device, such as a smartphone, tablet, laptop, etc. Such communication may be wired or wireless and, in certain implementations, may be by a short-range communication protocol, such as, but not limited to, Bluetooth or Near Field Communication (NFC).

Various modifications and additions can be made to the exemplary implementations discussed without departing from the scope of the present invention. For example, while the implementations described above refer to specific features, the scope of this invention also includes implementations having different combinations of features and implementations that do not include all the described features. Accordingly, the scope of the present invention is intended to embrace all such alternatives, modifications, and variations together with all equivalents thereof.

We claim:

1. An assay device comprising:
an electrochemical testing assembly including:
a test channel including a capture reagent selected to capture a target analyte; and
an electrode having a surface in communication with the test channel;
a microfluidic network in communication with the test channel;
a buffer fluid inlet in communication with the microfluidic network; and
a detection reagent disposed within the microfluidic network,
wherein, when a buffer fluid is provided to the buffer fluid inlet, the buffer fluid transports the detection reagent to the test channel by capillary-driven flow, and wherein the electrode is configured to measure an electrical response indicating capture of the target analyte by the capture reagent after transportation of the detection reagent to the test channel.

2. The assay device of claim 1, wherein the detection reagent is an electrochemical mediator, and wherein the target analyte inhibits interaction between the electrochemical mediator and the electrode when the target analyte is captured by the capture reagent.

3. The assay device of claim 1, wherein the detection reagent is a label selected to bind with the target analyte when the target analyte is captured by the capture reagent, and wherein the label is selected to react with a substrate when the label is bound to the target analyte to produce an electrochemically active product detectable by the electrode.

4. The assay device of claim 1, further comprising a substrate inlet in communication with the microfluidic network, wherein, when a substrate is provided to the substrate inlet, the substrate is transported by capillary-driven flow to the test channel.

5. The assay device of claim 1, wherein the detection reagent is one of a dried label and a dried substrate disposed within the microfluidic network, and wherein, when the buffer fluid is provided to the buffer fluid inlet, the buffer fluid rehydrates the detection reagent before transporting the detection reagent to the test channel.

6. The assay device of claim 1, wherein the detection reagent is a first detection reagent including a label, wherein the assay device further comprises a second detection reagent disposed within the microfluidic network, wherein the second detection reagent includes a substrate, and wherein, when the buffer fluid is provided to the buffer fluid inlet, the buffer fluid transports the first detection reagent to the test channel before the second detection reagent.

7. The assay device of claim 1, wherein the capture reagent is disposed on the surface of the electrode.

8. The assay device of claim 1 further comprising a membrane in communication with the microfluidic network and a passive pump coupled to the membrane, wherein the passive pump facilitates capillary-driven flow of the buffer fluid through the microfluidic network when the buffer fluid is provided to the buffer fluid inlet.

9. The assay device of claim 1 further comprising a sample inlet in communication with the microfluidic channel.

10. The assay device of claim 1 further comprising a sample inlet in communication with the microfluidic channel, wherein the sample inlet includes a filtration membrane.

11. A method of performing an electrochemical assay comprising:
receiving a buffer fluid at a buffer fluid inlet of an assay device, wherein the assay device includes a microfluidic network in communication with each of the buffer fluid inlet and an electrochemical testing assembly, wherein the electrochemical testing assembly includes a test channel in communication with the microfluidic network, a capture reagent disposed within the test channel and selected to capture a target analyte, and an electrode having a surface in communication with the test channel;
driving capillary flow of a detection reagent disposed within the microfluidic network to the test channel to the test channel using the buffer fluid; and
measuring an electrical response with the electrode after arrival of the detection reagent in the test channel, wherein the electrical response indicates capture of the target analyte by the capture reagent.

12. The method of claim 11, wherein the detection reagent is an electrochemical mediator, and wherein the target analyte inhibits interaction between the electrochemical mediator and the electrode when the target analyte is captured by the capture reagent.

13. The method of claim 11, wherein the detection reagent is a label selected to bind with the target analyte when the target analyte is captured by the capture reagent, and wherein the label is selected to react with a substrate when the label is bound to the target analyte to produce an electrochemically active product detectable by the electrode.

14. The method of claim 11, further comprising:
receiving a substrate at a substrate inlet of the assay device, wherein the substrate inlet is in communication with the microfluidic network; and
transporting the substrate to the test channel by capillary flow.

15. The method of claim 11, wherein the detection reagent is one of a dried label and a dried substrate disposed within the microfluidic network, the method further comprising rehydrating the detection reagent using the buffer fluid before transporting the detection reagent to the test channel.

16. The method of claim 11, wherein the detection reagent is a first detection reagent including a label, wherein the method further comprises driving capillary flow of a second detection reagent disposed within the microfluidic network to the test channel using the buffer fluid, wherein the second detection reagent includes a substrate, and wherein, the first detection reagent arrives at the test channel before the second test reagent.

17. The method of claim 11, wherein the capture reagent is disposed on the surface of the electrode.

18. The method of claim 11 further comprising:
receiving a sample by a sample inlet in communication with the microfluidic channel; and
filtering the sample using a membrane of the sample inlet.

19. A system comprising:
a computing device adapted to be communicatively coupled to an electrochemical assay device, wherein the electrochemical assay device includes:
an electrochemical testing assembly including:
a test channel including a capture reagent selected to capture a target analyte; and
an electrode having a surface in communication with the test channel;
a microfluidic network in communication with the test channel;
a buffer fluid inlet in communication with the microfluidic network; and
a detection reagent disposed within the microfluidic network,
wherein, when a buffer fluid is provided to the buffer fluid inlet, the buffer fluid transports the detection reagent to the test channel by capillary-driven flow, wherein the electrode is configured to measure an electrical response indicating capture of the target analyte by the capture reagent after transportation of the detection reagent to the test channel, and
wherein the computing device is configured to receive measurements from the electrode.

20. The system of claim 19, wherein the computing device is configured to at least one of display the measurements on a display of the computing device, store the measurements in a memory of the computing device, and transmit the measurements to a second computing device.
